(19) United States
(12) Patent Application Publication
(10) Pub. No.: US 2014/0187301 A1
(43) Pub. Date: Jul. 3, 2014

(54) Predictive Sports-Based Platform with a Charity Tie-In

(71) Applicant: Jared Jeremy Ginsberg, Long Beach, NY (US)

(72) Inventor: Jared Jeremy Ginsberg, Long Beach, NY (US)

(21) Appl. No.: 13/732,007

(22) Filed: Dec. 31, 2012

(51) Int. Cl. G07F 17/32

(52) U.S. Cl. CPC G07F 17/3276; G07F 17/3288; G07F 17/3295
USPC 463/9

(57) ABSTRACT

A method and apparatus for a contest based on the accuracy of predictions for a future sports event is described. A participant in a sports event or a contest sponsor associates with a philanthropic organization. The contest sponsor may advertise the association between the contest sponsor or participant. An entrant in the contest associates with the contest sponsor or participant and thereby the chosen philanthropic organization.

### FIELD OF THE DISCLOSURE

The present disclosure relates generally to sports-related prediction and fantasy gaming apparatus and methods and more particularly to such prediction techniques being used to benefit charities and other philanthropic organizations of interest to predictive sports-based contest sponsors, athletes, sports teams, sports leagues and their fans.

### BACKGROUND

Every sports event produces a large amount of analyzable data. Sports fans derive enjoyment from analyzing this data and predicting future events based on past performance of favorite athletes and their teams. And sports fans participate in games that simulate teams based on preset past data conditions to determine how changes in conditions might have altered the actual result. Such fans often participate in “fantasy” play or other simulation-related games to compete against other fans in their ability to predict future events. Taken together, these activities increase involvement and enjoyment of the sport for the fans, which in turn generates more revenue for the sports league, the sports teams and the athletes.

In addition, sports contest sponsors, sports leagues, sports teams and athletes are often associated with philanthropic organizations as a means to give to worthy causes. A sports contest sponsor, sports league, sports team or athlete often publicizes these associations as means to encourage others to give to these worthy causes and as a means to promote their involvement in the community at large. Fans that follow sports and participate in sports contests are often interested in all aspects of their favorite league, team or athlete and may desire to be informed about, and to participate in, such philanthropic activities that are associated with that contest, league, team or athlete.

Accordingly, there is a need for a method and apparatus for participants that use sports-related data for gaming, predicting or fantasy play to associate such play with philanthropic organizations of interest to sports contests, sports leagues, sports teams or athletes.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a flowchart of a sports-related contest in accordance with some embodiments.

FIG. 2 is a flowchart of a sports-related contest with a charity tie-in in accordance with some embodiments.

FIG. 3 is a flowchart of a sports-related contest involving seed-based predictions with a charity tie-in in accordance with some embodiments.

### DETAILED DESCRIPTION

As set forth in further detail, described herein are embodiments for participants that use sports-related data for gaming, predicting or fantasy play to associate such play with philanthropic organizations of interest to sports contests, sports leagues, sports teams or athletes and their fans.

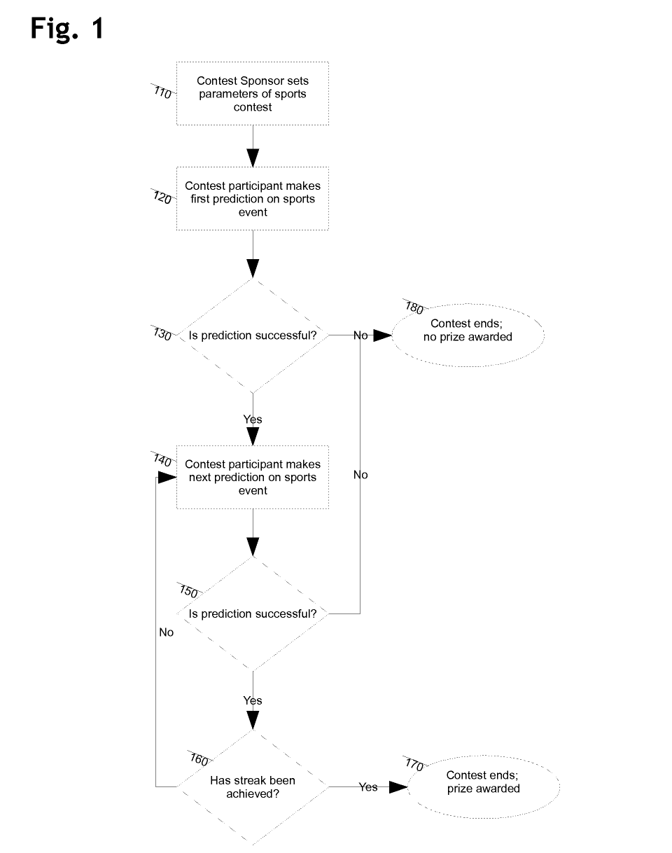

FIG. 1 is a block diagram showing an exemplary predictive sports-based platform. A contest sponsor sets up a sports-based contest for fans to enter (using paper or electronic format) 110. The contest sponsor sets parameters for contest entrants to predict sports-related events that will occur on a game-by-game, event-by-event or statistic-by-statistic basis. Such contests may be provided on a no-fee basis or the contest sponsor may collect a fee from the contest entrant for participation.

As an exemplary basis for the scheme, a contest entrant makes a prediction regarding a predetermined game, event or statistic 120. The prediction is then compared against the actual event 130. For those contest entrants who are incorrect, the contest ends 180. Those that correctly predict the first game, event or statistic are then eligible to proceed to the next round where the contest entrant must predict another game, event or statistic 140, which could be the same or different in kind from the first round.

The second prediction is then compared against the actual event 150. For those contest entrants who are incorrect, the contest ends 180. For those content participants who are correct, a determination is made whether the “streak” of successful predictions is long enough to win the contest 160. If the “streak” is long enough, the participant wins the contest and wins a prize 170. If the “streak” is not long enough, the process then repeats 140.

The examples of statistics that can be used for contest events and “streak” building are numerous. For U.S. football, it may be rushing yards, passing yards, receiving yards, passing touchdowns, rushing touchdowns, receiving touchdowns, sacks or interceptions of a particular player or team during one game or a series of games. For U.S. baseball, it may be steals and runs for position players and wins and saves for pitchers. For U.S. basketball, it may be points scored, rebounds or achieving “double-doubles” (in which a player accumulates a double-digit number total in two of five statistical categories—points, rebounds, assists, steals, and blocked shots—in a game). For U.S. hockey, it may be goals, saves or some combination of the above. Other sports offer similar opportunities for developing “streaks.”

The contest sponsor may provide for prizes for contest entrants based on the length of the “streak.” The contest sponsor may publicize the existence of developing “streaks” and successful “streaks” to promote the contest and to give other fans, sports leagues, sports teams and athletes a rooting interest in the outcome of the next round. Such promotion may include the use of advertisements, promotions and social media. The contest sponsor may initiate multiple overlapping prediction events in order to provide additional interest in the overall contest. The contest sponsor may provide that a contest entrant cannot base more than one round's prediction on the same athlete or event within a contest. The contest sponsor may also hedge against the risk of payouts that would be excessive to the sponsor by purchasing insurance that would provide the necessary prize money to be paid in the unlikely event that a contest entrant receives a large prize based on a very long successful “streak.”

In addition to providing the capability for members of the public to participate in contests that are open to all (which may be called “public leagues”), the contest sponsor may also choose to provide the infrastructure for contest entrants to set up contests of their own (which may be called “private leagues”). Under this infrastructure, one or more contest entrants may determine who may be admitted to a private league. The contest sponsor may arrange for the public leagues and private leagues to engage in multiple overlapping prediction events in order to provide additional interest in the overall contest.

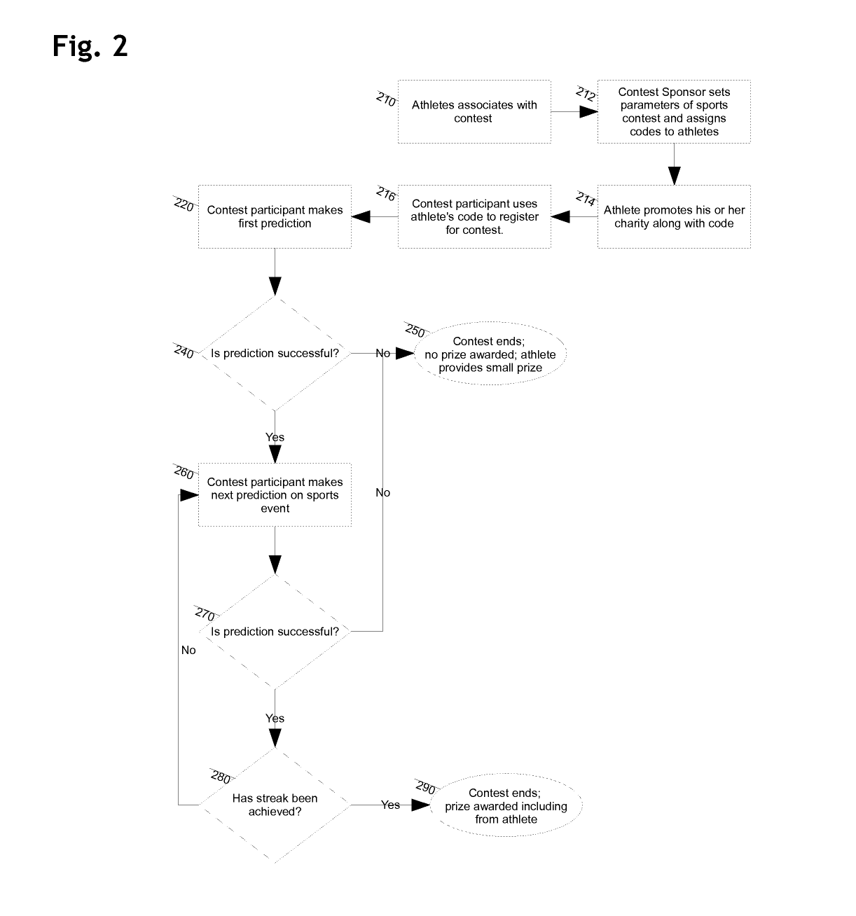

FIG. 2 demonstrates further feature of these sports-related contests with a charity tie-in. In addition to providing predictions based on sporting events, the contest sponsor may arrange for the contest entrant to associate his or her participation with one or more philanthropic organizations. These philanthropic organizations may be associated with the contest sponsor or contest entrant directly. In addition, the philanthropic organizations may be associated with (or sponsored by) the sports league, sports team and/or athletes that provide the underlying statistics for the contest. The contest sponsor may provide or make available an affinity code for contest entrants to use when entering the contest to identify the particular philanthropic organization that the contest entrant is interested in assisting. The contest sponsor may then donate part of the fee received from the contest entrant to the chosen philanthropic organization. In this way, those fans that identify with a contest sponsor, sports team, sports league or athlete may also identify with that entity's chosen philanthropic organization.

As an example, an athlete may associate with a contest sponsor engaged in a predictive contest 210. The contest sponsor then determines the parameters of the contest, including assigning the athlete a promotional code to provide to the athlete's fans when entering the contest 212. Once a code is established, the athlete may then encourage fans that follow that athlete to enter a particular contest 214. The athlete may publicize a promotional code to the fans that interested participants enter when joining the contest. When the participant enters the code while joining the contest, the contest sponsor associates that participation with the particular athlete 216.

A contest entrant makes a prediction regarding a predetermined game, event or statistic 220. The prediction may or may not be related to the performance of the sponsoring athlete, sports team or sports league. The prediction is then compared against the actual event 240. For those contest entrants who are incorrect, the contest ends 250. Those that correctly predict the first game, event or statistic are then eligible to proceed to the next round where the contest entrant must predict another game, event or statistic 260, which could be the same or different in kind from the first round.

The second prediction is then compared against the actual event 270. For those contest entrants who are incorrect, the contest ends 250. For those content participants who are correct, a determination is made whether the “streak” of successful predictions is long enough to win the contest 280. If the “streak” is long enough, the participant wins the contest and wins a prize 290. If the “streak” is not long enough, the process then repeats 260.

By using this technique, the contest sponsor, sports team, sports league or athlete with an interest in a specific charity or foundation may promote its interest via the contest by social media or other means. The contest sponsor may remit a percentage of fees collected from the contest entrants to the philanthropic organizations affiliated with contest sponsor itself, sports team, sports league or athlete. This creates an affinity between the contest sponsor, sports team, sports league or athlete, its charity of choice and its fans.

The contest sponsor may provide different techniques for prediction-based contests other than the “streak”-based method described above. For example, the contest sponsor may provide for a “survivor”-based contest (also known as suicide, eliminator, last man standing, or king of the hill contest) where each contest entrant pick one sports event to occur per time period, with our without taking a point spread into account. Those that predicted the event correctly advance to the next round. Contest sponsors may also choose to allow for “Mulligans” to reinstate contest entrants that were eliminated from early rounds. Alternatively, the contest could be run over a period of events with the winner of the contest being the participant that wins over a predetermined period of time.

Another type of contest may be the “confidence” system where each contest entrant pick multiple sports event to occur per time period, with our without taking a point spread into account. The contest entrant assigns a point value as to how confident he or she is with each prediction. Those that predict events beyond a predetermined threshold advance to the next round.

Another type of contest may be the tournament-based contests that may be used for popular single-elimination tournaments such as the NCAA college basketball playoffs. In this contest, contest entrants make predictions for all events that will take place in a particular tournament. The contest sponsor awards points for each correct pick and these points increase as the tournament progresses.

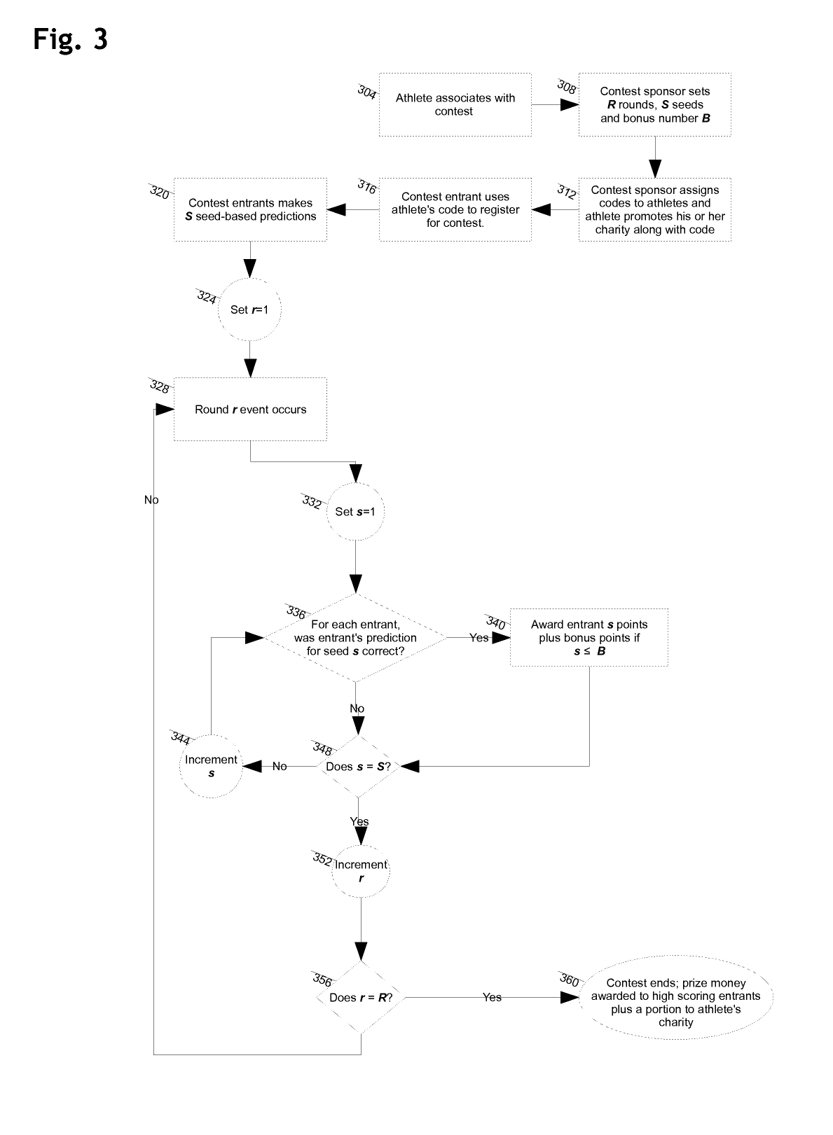

FIG. 3 demonstrates a sports-related contest involving seed-based predictions with a charity tie-in. The contest sponsor may use a unique seed-based contest suitable for multiple round single-elimination tournaments. The contest sponsor arranges for the contest entrant to associate his or her participation with one or more philanthropic organizations. These philanthropic organizations may be associated with the contest sponsor or contest entrant directly. In addition, the philanthropic organizations may be associated with (or sponsored by) the sports league, sports team and/or athletes that provide the underlying statistics for the contest. The contest sponsor may provide or make available an affinity code for contest entrants to use when entering the contest to identify the particular philanthropic organization that the contest entrant is interested in assisting. The contest sponsor may then donate part of the fee received from the contest entrant to the chosen philanthropic organization. In this way, those fans that identify with a contest sponsor, sports team, sports league or athlete may also identify with that entity's chosen philanthropic organization.

As an example, an athlete may associate with a contest sponsor engaged in a predictive seed-based contest where there are multiple entrants with the same seed within an athletic competition 304. The contest sponsor sets the rules for the contest based on R rounds and S seeds and sets a bonus number B 308. As a further example, a 64-team single elimination tournament may have 4 sets of 16 seeded entrants with 6 rounds of play to reach a winner. The contest sponsor may then determine that predictions of the top 3 seeds will be awarded bonus points. In this example, therefore, R is 6, S is 16 and B is 3.

The contest sponsor assigns the athlete a promotional code to provide to the athlete's fans when entering the contest and the athlete may then encourage fans that follow that athlete to enter a particular contest 312. The athlete may publicize a promotional code to the fans that interested participants enter when joining the contest. When the participant enters the code while joining the contest, the contest sponsor associates that participation with the particular athlete 316.

A contest entrant then makes S predictions as to which team with seed 1 through S will advance in the tournament 320. To determine the amount of points assigned to each entrant, the following algorithm is used. The round number r begins at 1 324. After each round r event 328, the seed number s for each entrant is set to 1 332. A comparison is then made to determine if the entrant correctly predicted the victory of seed s in round r 336. If the prediction was correct, the contest sponsor awards the entrant s points. Further, if the prediction was correct and s is less than or equal to the predetermined bonus number B, the contest sponsor may awards the entrant bonus points 340, which may increase as r increases. This bonus is designed to reward the entrant for higher-seed predictions and to balance the fact that the contest otherwise awards entrants higher points for lower-seed predictions. If the prediction was not correct (or the predicted team did not play in round r because it was eliminated in earlier rounds), then no points are rewarded. If the seed value is less than the total seeds S, s is incremented by 1 344 and the process repeats 336. If the seed value s equals the total seeds S 348, then r is incremented by 1 352. If the round value r is less than the total rounds R 356, then contest continues for the next round r 328. If the round value r equals the total rounds R 356, then contest ends 360.

Upon the end of the contest, the contest sponsor may distribute a portion of the fees collected from the contest entrants to the winning entrants and a portion to the charity identified by the entrants. The charity may be associated with an athlete, the contest sponsor, the contest entrant, a sports team or sports league.

The methods and apparatus that may be used to accomplish the above are numerous. The contests sponsors, contest entrants, philanthropic organizations, sports leagues, sports teams and athletes may use paper-based systems or electronic-based systems or a combination of the two. The paper-based systems may incorporate the use of newspapers, periodicals, newsletter, board games and the like. The electronic-based systems may incorporate the use of electronic mail, web pages, social media, mobile devices, telephonic devices, desktop devices and the like. Systems may be stand-alone devices or methods capable of operating the contests as described or devices or methods that are designed to operate the contest as described on a pre-existing platform.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A method comprising:
establishing a contest based on the accuracy of predictions for a plurality of future sports events, the contest having a plurality of entrants;
associating the contest with a participant in the future sports event;
associating the contest with at least one philanthropic organization;
advertising the association between the contest and at least one philanthropic organization; and
associating at least one of the plurality of entrants with at least one philanthropic organization.

2. The method of claim 1, further comprising:
collecting an entry fee from the plurality of entrants; and
distributing a portion of the entry fee to at least one philanthropic organization.

3. The method of claim 2, wherein the participant is an individual athlete.

4. The method of claim 2, wherein the participant is a sports team.

5. The method of claim 2, further comprising:
distributing an item associated with the participant to at least one of the plurality of entrants.

6. The method of claim 5, wherein the item is distributed to the entrant that achieves a correct prediction of a consecutive series of future sports events.

7. The method of claim 5, wherein the item is distributed to the entrant that achieves a correct prediction of a series of future single-elimination sports tournaments.

8. The method of claim 7, wherein the correct prediction is associated with a point system that awards points related to seed-based predictions.

9. The method of claim 8, wherein the point system also awards additional points related to lower seed-based predictions.

10. An apparatus comprising:
a contest based on the accuracy of predictions for a future sports event, the contest having a plurality of entrants;
a participant in the future sports event;
a philanthropic organization;
an association between the participant and the philanthropic organization;
an advertisement publicizing the association between the participant and the philanthropic organization; and
an association between at least one of the plurality of entrants and the philanthropic organization.

11. The apparatus of claim 10, further comprising:
a fee collected from the entrant to enter into the contest, a portion of the fee being designated for the philanthropic organization associated with the entrant.

12. The apparatus of claim 11, wherein the participant is an individual athlete.

13. The apparatus of claim 11, wherein the participant is a sports team.

14. The apparatus of claim 11, further comprising:
an item associated with the participant, the item being designated for distribution to the entrant.

15. The apparatus of claim 14, wherein the item is distributed to the entrant that achieves a correct prediction of a consecutive series of future sports events.

16. The apparatus of claim 14, wherein the item is distributed to the entrant that achieves a correct prediction of a series of future single-elimination sports tournaments.

17. The apparatus of claim 16, wherein the correct prediction is associated with a point system that awards points related to seed-based predictions.

18. The apparatus of claim 17, wherein the point system also awards additional points related to lower seed-based predictions.

19. A content-based electronic portal comprising:
a contest based on the accuracy of predictions for a plurality of future sports events, the contest having a plurality of entrants and the contest being associated with at least one philanthropic organization;
an advertisement publicizing the association between the contest and at least one philanthropic organization; and
an association between at least one of the plurality of entrants with at least one philanthropic organization.
a fee collected from the entrant to enter into the competition, a portion of the fee being designated for the philanthropic organization associated with at least one of the plurality of entrants.

20. The content-based electronic portal of claim 19, further comprising:
an item associated with a participant in the plurality of future sport events, the item being designated for distribution to at least one of the plurality of entrants.
